(19) United States
(12) Patent Application Publication
(10) Pub. No.: US 2026/0043983 A1
(43) Pub. Date: Feb. 12, 2026

(54) CAMERA MODULE

(71) Applicant: JAHWA ELECTRONICS CO., LTD., Cheongju-si, Chungcheongbuk-do (KR)

(72) Inventor: In Soo KIM, Bucheon-si (KR)

(21) Appl. No.: 19/101,326

(22) PCT Filed: Aug. 2, 2023
(86) PCT No.: PCT/KR2023/011340

§ 371 Date: Feb. 5, 2025

(30) Foreign Application Priority Data
Oct. 26, 2022 (KR) 10-2022-0139050

(51) Int. Cl. G02B 7/02

(52) U.S. Cl. CPC G02B 7/02

(57) ABSTRACT

Provided is a camera module. A camera module according to one aspect of the present invention comprises: a lens; a frame in which the lens is accommodated; a support member disposed inside the frame and having a first portion exposed to the outside of the frame; and a stopper coupled to the frame to form a space for accommodating the lens, wherein the stopper may further comprise a second portion directly coupled to the first portion.

### TECHNICAL FIELD

The present invention relates to a camera module, and more particularly, to a camera module capable of safely protecting components mounted therein.

### BACKGROUND

As hardware technology for image processing develops and user needs for image shooting increase, various functions such as auto focus (AF) and optical image stabilization (OIS) are being implemented in camera modules mounted on mobile terminals such as mobile phones and smartphones as well as independent camera devices.

Auto focus (autofocus control) function refers to a function that linearly moves a carrier equipped with a lens, etc. in the optical axis direction to adjust the focal length to the subject so that a clear image is generated on an image sensor (CMOS, CCD, etc.) provided at the rear end of the lens.

In addition, the optical image stabilization function refers to improving the image's clarity by adaptively moving the carrier equipped with the lens in the direction of compensating for the shaking of the lens when the lens is shaken by the hand tremor.

In order to implement the above-described functions, a plurality of carriers and various driving units separated from each other are mounted in one base (frame), and in this case, a kind of stopper is employed in the form of coupling with the base to prevent the components mounted on the base from being separated to the outside and losing its function.

Recently, as camera modules are miniaturized, the base (frame) and the like are typically made of resin injection products, whereas the stopper is typically made of a thin piece of metal. However, the camera module with the above-described structure has a weak fastening force between the stopper and the resin injection components when a strong impact is transmitted from the outside, causing the stopper and resin injection products to be easily separated.

### DISCLOSURE

### Technical Problem

The present invention is directed to providing a camera module with increased fastening force between a frame and a stopper.

The problems of the present invention are not limited to those mentioned above, and other problems not mentioned will be clearly understood by those of ordinary skill in the art from the following description.

### Technical Solution

A camera module according to one aspect of the present invention may include a lens; a frame in which the lens is accommodated; a support member disposed inside the frame and having a first portion exposed to the outside of the frame; and a stopper coupled to the frame to form a space for accommodating the lens, wherein the stopper further includes a second portion directly coupled to the first portion.

In this case, the camera module may further include a first frame mounted with the lens to drive forward and backward along an optical axis direction.

In this case, the camera module may further include a second frame disposed between the lens and the first frame or in which the first frame is mounted to drive forward and backward in a direction perpendicular to the optical axis.

In this case, the camera module may further include a third frame in which the first to second frames are mounted so that they can move forward and backward.

In this case, in the camera module, the support member may be integrally injected with the frame such that the first portion is exposed to the outside of the frame.

In the camera module, the stopper and the support member may be made of the same metal material.

### Advantageous Effect

The camera module according to an exemplary embodiment of the present invention may include a stopper protrusion exposed to the outside, thereby increasing the fastening force between the stopper and the frame.

Advantageous effects of the present invention are not limited to the above-described effects, and should be understood to include all effects that can be inferred from the configuration of the invention described in the description or claims of the present invention.

### BRIEF DESCRIPTION OF THE DRAWINGS

FIG. 1 is a perspective view of a camera module according to an exemplary embodiment of the present invention.

FIG. 2 is an exploded perspective view of a camera module viewed from one direction according to an exemplary embodiment of the present invention.

FIG. 3 is an exploded perspective view of a camera module viewed from another direction according to an exemplary embodiment of the present invention.

FIG. 4 is a perspective view of a first frame and a stopper of a camera module according to an exemplary embodiment of the present invention.

FIG. 5 is an exploded perspective view of a first frame and a stopper of a camera module according to an exemplary embodiment of the present invention.

FIG. 6 is a side view of a first frame and a stopper of a camera module according to an exemplary embodiment of the present invention.

FIG. 7 is a side view of a first frame of a camera module according to an exemplary embodiment of the present invention.

FIG. 8 is a cross-sectional view illustrating a cross-section taken along line A-A of FIG. 4.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Hereinafter, a camera module 1 according to an exemplary embodiment of the present invention will be described with reference to the accompanying drawings.

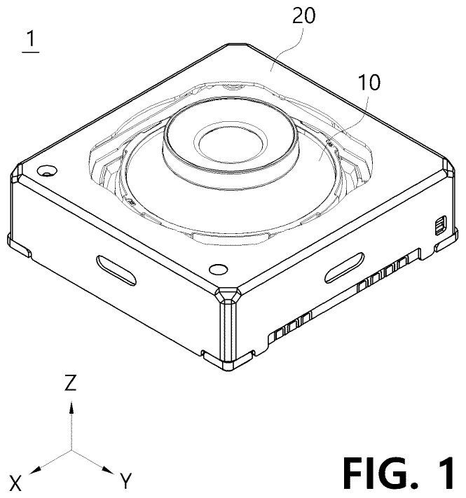

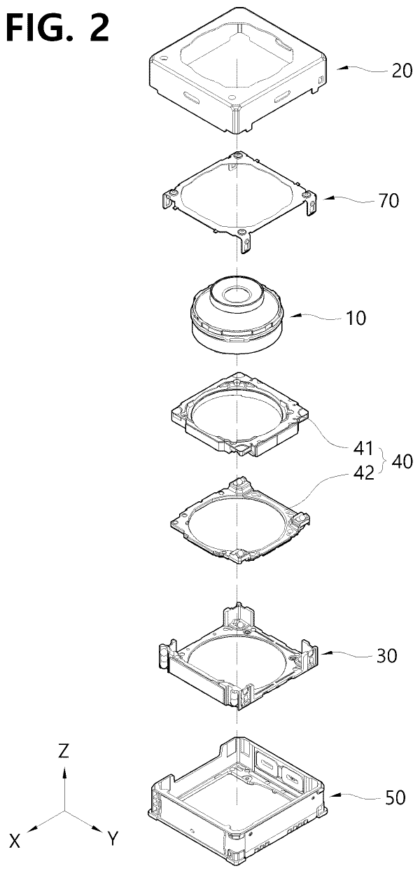

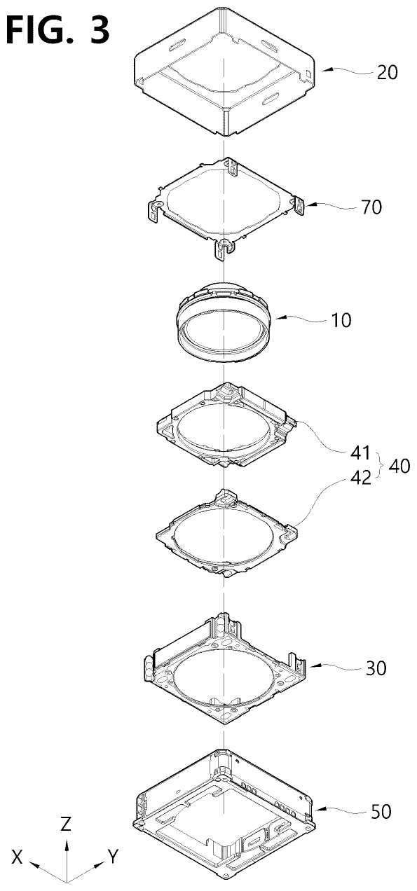

FIG. 1 is a perspective view of a camera module according to an exemplary embodiment of the present invention. FIG. 2 is an exploded perspective view of a camera module viewed from one direction according to an exemplary embodiment of the present invention. FIG. 3 is an exploded perspective view of a camera module viewed from another direction according to an exemplary embodiment of the present invention.

The camera module 1 according to an exemplary embodiment of the present invention is an embodiment in which auto-focus (AF) and optical image stabilization (OIS) are implemented together by driving the lens 10, but the camera module 1 of the present invention may be implemented as a camera module only for AF or OIS depending on the embodiment.

The Z-axis direction shown in the drawing is an optical axis direction, which is a direction in which light flows into the lens 10, and corresponds to a direction in which a first frame 30, which will be described later, moves forward and backward. And, the optical axis means the central axis of the image sensor.

In addition, the two directions perpendicular to the optical axis direction (Z-axis direction), the X-axis direction and Y-axis direction, mean the direction in which the lens 10 moves by OIS driving to compensate for shaking caused by hand tremor.

In the following description, the X-axis direction is referred to as the first direction and the Y-axis direction is referred to as the second direction, but this is only an example according to a relative viewpoint, and any one of the X-axis direction and the Y-axis direction may be the first direction and the other direction may be the second direction. In addition, the first direction and the second direction do not coincide, but they do not necessarily have to be vertical.

The camera module 1 according to an exemplary embodiment of the present invention may include a lens 10, a case 20, a frame, a support member 60, and a stopper 70.

The lens 10 may have a hollow cylindrical shape so that a plurality of optical lenses imaging a subject can be accommodated therein, and a plurality of optical lenses are mounted in the lens 10 along the optical axis. The plurality of optical lenses are arranged in the required number according to the design of the lens 10, and each optical lens has optical characteristics such as the same or different refractive index.

The above-described frame is a structure for moving the lens 10. The frame may adjust the focus by moving the lens 10 in the optical axis direction, and may correct shaking during photographing by moving it in a direction perpendicular to the optical axis.

The frame may consist of a first frame 30, a second frame 40, and a third frame 50. Accordingly, the camera module 1 according to an exemplary embodiment of the present invention may have a structure in which the first frame 30, the second frame 40, the lens 10, the stopper 70, and the third frame 50 are sequentially coupled, and in a state in which the components are combined, the case 20 may be mounted while exposing the lens 10.

In this case, the lens 10, the first frame 30, and the second frame 40 are accommodated in the third frame 50. The third frame 50 has a shape in which upper and lower portions are open, and an image sensor may be disposed in the lower portion of the third frame 50.

The case 20 is coupled to the third frame 50 to surround the outer surface of the third frame 50 and functions to protect the internal components of the camera module 1.

In addition, the case 20 may provide a function of shielding electromagnetic waves. The case 20 may shield electromagnetic waves so that the electromagnetic waves generated by the camera module do not affect other electronic components in the portable electronic device.

In addition, since portable electronic devices are equipped with several electronic components in addition to the camera module, the case 20 may shield electromagnetic waves so that the electromagnetic waves generated by these electronic components do not affect the camera module.

The case 20 is made of a metal material and may be grounded to a ground pad provided on a printed circuit board, thereby shielding electromagnetic waves.

Meanwhile, the image sensor converts light incident through the lens 10 into an electrical signal. The image sensor may be a charge-coupled device (CCD) or a component metal-oxide semiconductor (CMOS).

In the camera module 1 according to an exemplary embodiment of the present invention, the lens 10 is moved to focus the subject through the frame.

The present invention includes a first frame 30 for moving the lens 10 in the optical axis direction. In this case, the first frame 30 provides a structure capable of moving the lens 10 in the optical axis direction.

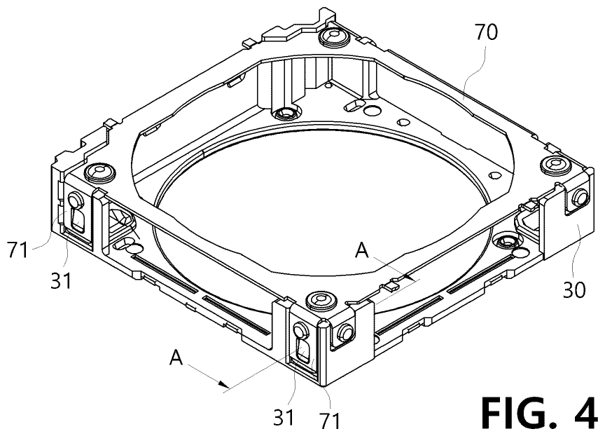

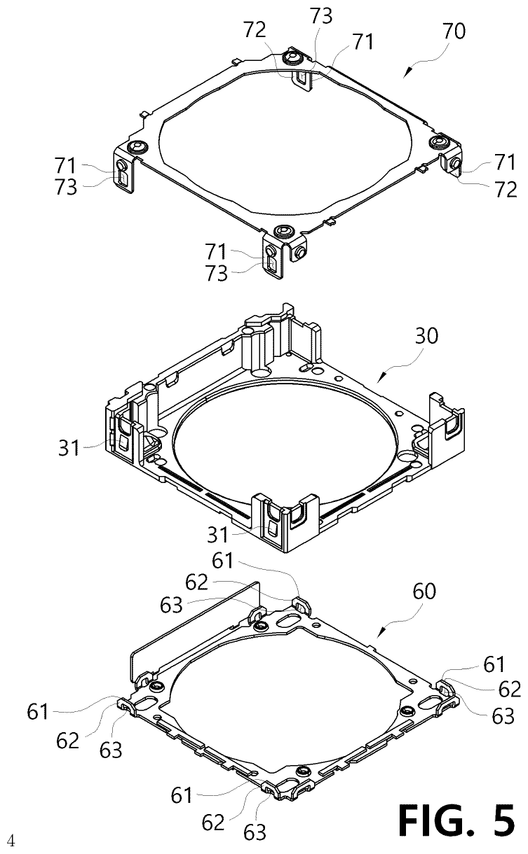

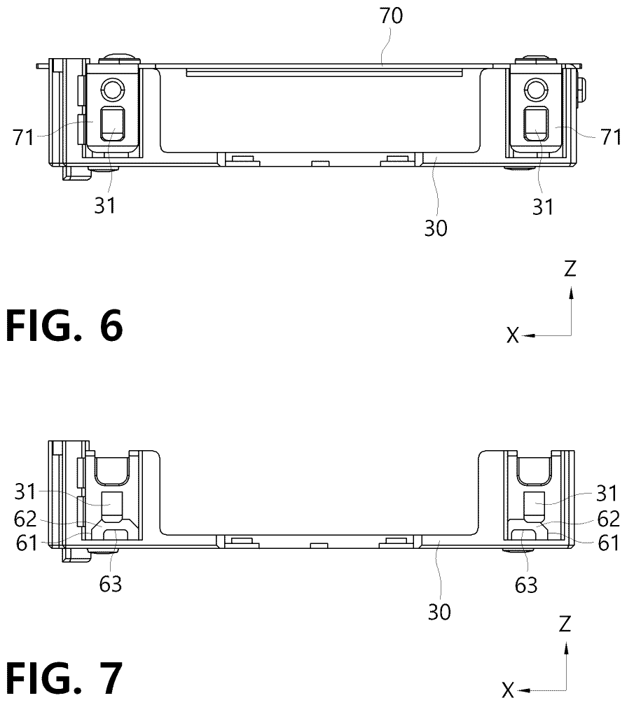

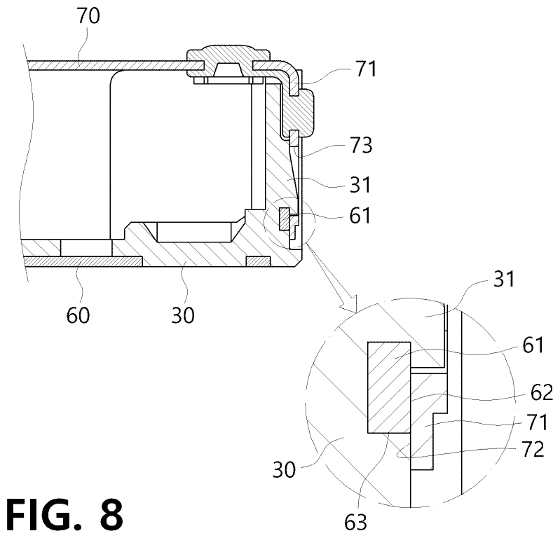

FIG. 4 is a perspective view of a first frame and a stopper of a camera module according to an exemplary embodiment of the present invention. FIG. 5 is an exploded perspective view of a first frame and a stopper of a camera module according to an exemplary embodiment of the present invention. FIG. 6 is a side view of a first frame and a stopper of a camera module according to an exemplary embodiment of the present invention. FIG. 7 is a side view of a first frame of a camera module according to an exemplary embodiment of the present invention. FIG. 8 is a cross-sectional view illustrating a cross-section taken along line A-A of FIG. 4.

As shown in FIGS. 2 and 3, the lens 10 is accommodated in the first frame 30. In this case, the lens 10 may be directly coupled to the first frame 30 and accommodated, or may be accommodated in the first frame 30 while being accommodated in the second frame 40. In the present embodiment, it is described that it is accommodated in the first frame 30 while being accommodated in the second frame 40.

A driving unit is coupled to the outside of the first frame 30. The driving unit provides an external force to move the lens 10 in the optical axis direction. There is no limitation on the type of external force provided by the driving unit to the first frame 30. In the present embodiment, it is described that the driving unit moves the first frame 30 by providing an electromagnetic force.

In this case, in the present embodiment, the driving unit provides an external force to the first frame 30 so that the first frame 30 may move in the optical axis direction. However, the present invention is not limited thereto, and an external force may be provided to move the first frame 30 in the first direction or the second direction as necessary.

As in the present embodiment, when the first frame 30 is moved in the optical axis direction by the driving unit, the first frame 30 becomes an auto-focus (AF) carrier for auto-focus.

The first frame 30 may support one side of the lens 10. As shown in FIG. 5, the first frame 30 has an opening formed at the center thereof. Through the opening, the image sensor may detect light introduced through the lens 10.

The shape of the first frame 30 is not limited as long as it may accommodate the lens 10. In the present embodiment, as shown in FIG. 5, it is formed in a shape in which four support parts protruding upward are provided at four corner parts of the body of the square plate shape including the opening. In addition, a sidewall may be formed between two adjacent support parts among the four support parts.

In this case, there is no limitation on the material for manufacturing the first frame 30. However, in line with the trend of requiring miniaturization of camera modules, it is preferable to make it with plastic, which is a material that is easy to manufacture in a small size.

The support member 60 is disposed inside the frame for rigidity of the frame. In this case, the support member 60 may be disposed inside one or all of the first frame 30, the second frame 40, or the third frame 50 as needed.

Since the support member 60 is disposed inside the frame for rigidity of the frame, a material with high rigidity is used. In the present embodiment, it is described that the support member 60 is manufactured using a metal material.

It is preferable that the frame and the support member 60 are manufactured so that they are attached and not to be separated. In the present embodiment, it is described that insert injection is used to manufacture the frame and the support member 60 not to be separated by injection of the frame on the outer surface of the support member 60. However, it is not limited thereto, and may be manufactured through other known methods.

In this case, the support member 60 is insert-injected with one of the first frame 30, the second frame 40, or the third frame 50 as needed. Hereinafter, it will be described that the support member 60 is insert-injected into the first frame 30. However, it is not limited thereto, and the description of the structure in which the support member 60 is insert-injected and coupled to the stopper 70 to be described later can be understood as a description of the content in which the support member 60 is insert-injected into the second frame 40 or the third frame 50 and the support member 60 can be coupled to the stopper 70.

The support member 60 is disposed inside the first frame 30 so that a portion thereof is exposed to the outside. As shown in FIG. 7, a part of the support member 60 on the side surface of the first frame 30 is exposed to the outside. In this case, the side surface of the support part protruding from the corner part of the first frame 30 and the exposed portion of the support member 60 may be formed so as not to cause a step difference. In this case, the portion of the support member 60 exposed to the outside is defined as a first portion 62.

As shown in FIG. 5, the support member 60 is formed to be placed inside the first frame 30 to increase the rigidity of the first frame 30. That is, the support member 60 is formed in a plate shape having an opening corresponding to the opening of the first frame 30.

In this case, a support member protrusion 61 protruding in the optical axis direction is formed at the edge portion of the support member 60. That is, the support member protrusion 61 is formed to protrude upward from the outermost side of the support member 60. Accordingly, the first portion 62 is located on the outer surface of the support member protrusion 61 protruding upward.

There is no limitation on a method in which the support member protrusion 61 is formed as long as it protrudes upward. In the present embodiment, it is described that the support member protrusion 61 has a structure in which the support member protrusion 61 protrudes upward by bending upward from the end of the support member 60.

A support member through-hole 63 is formed in the support member protrusion 61. The support member through-hole 63 may be formed perpendicular to the first portion 62. However, it does not necessarily have to be formed perpendicular to the first portion 62, and there is no limitation on the shape of the inner circumferential surface of the support member through-hole 63 as long as it can penetrate in a direction perpendicular to the first portion 62.

When the support member through-hole 63 is formed, the support member through-hole 63 allows the material to enter the support member through-hole 63 even if the first portion 62 of the support member protrusion 61 is exposed to the outside during the injection of the first frame 30. Accordingly, the first frame 30 and the support member 60 can be firmly attached to each other to increase the rigidity of the first frame 30.

The first portion 62 exposed to the outside may have different areas or shapes as needed. That is, the exposed area and shape of the first part 62 may be determined by comparing the effect of increasing the adhesion with the stopper 70 to be described later due to the exposure of the first portion 62 and the effect of reducing the adhesion between the first frame 30 and the support member 60 due to the exposure of the first portion 62.

The support member protrusion 61 may be formed in plural. In this case, as shown in FIG. 5, the support member protrusion 61 may be provided in pairs. In addition, it is preferable that a pair of support member protrusions 61 are arranged opposite to each other with the opening of the support member 60 in the center. In addition, multiple pairs of support member protrusions 61 may be disposed. In this case, as shown in FIG. 5, it is preferable to be disposed as far away as possible from each other in the first direction. This is to increase the fastening force with the stopper 70 to be described later.

The stopper 70 is coupled to the frame. The stopper 70 restricts the lens 10 from moving upward. The stopper 70 may be coupled to one of the first frame 30, the second frame 40, and the third frame 50. In this case, the support member 60 is insert-injected into the frame to which the stopper 70 is coupled.

Hereinafter, it will be described that the stopper 70 is coupled to the first frame 30. However, the present invention is not limited thereto, and the description of the structure in which the first frame 30 and the stopper 70 are coupled may be understood as a description of the content in which the second frame 40 or the third frame 50 and the stopper 70 may be coupled.

The stopper 70 is coupled to the upper portion of the first frame 30. The stopper 70 restricts the lens 10 and, in the present embodiment, the second frame 40 in which the lens 10 is accommodated from moving upward.

That is, the first frame 30 can support the second frame 40 including the lens 10 not to deviate downward, and the stopper 70 can support the second frame 40 not to deviate upward.

In this case, “can support” means that a predetermined space is formed between the first frame 30 and the stopper 70 so that the second frame 40 accommodated in the first frame 30 can move in the up-down direction, but the second frame 40 is supported by the first frame 30 when the second frame 40 is located at the lowermost end and is supported by the stopper 70 when the second frame 40 is located at the uppermost end.

One side of the stopper 70 is attached to and fixed to the first portion 62 of the support member 60. In this case, it is described that a portion of the stopper 70 attached to the first portion 62 is defined as a second portion 72. That is, the support member 60 includes a first portion 62, and the stopper 70 may be coupled such that the second portion 72 is in direct contact with the first portion 62.

In this case, the stopper 70 may be formed of the same metal material as the support member 60 exposed to the outside through the first portion 62. Accordingly, when the second portion 72 of the stopper 70 and the first portion 62 of the support member 60 are attached to each other, adhesion may be increased. This is because the adhesion between metallic materials is better than that between metallic and non-metallic materials.

In this case, there is no limitation on a method of attaching the first portion 62 and the second portion 72. For example, the first portion 62 and the second portion 72 may be adhered using an adhesive material, or the first portion 62 and the second portion 72 may be attached by welding.

As shown in FIG. 5, the second portion 72 of the stopper 70 is located on the inner surface of a stopper protrusion 71 protruding downward from the edge portion of the stopper 70. The stopper protrusion 71 is provided in the same number as the number of support member protrusions 61.

In addition, as shown in FIG. 5, the stopper protrusion 71 is disposed at a position corresponding to the position of the support member protrusion 61. Accordingly, while the second portion 72 of the stopper protrusion 71 is attached to the first portion 62 of the support member protrusion 61, the stopper 70 and the first frame 30 may be coupled to each other.

Meanwhile, as shown in FIGS. 5 to 7, in order to increase the coupling force between the stopper 70 and the first frame 30, a projection 31 protrudes from the side of the first frame 30, and a stopper through-hole 73 is formed in the stopper protrusion 71.

The projection 31 may be inserted into the stopper through-hole 73, and thus the stopper 70 may be firmly coupled to the first frame 30. In this case, the stopper 70 may be elastically deformed so that the projection 31 may be inserted into the stopper protrusion 71.

The projection 31 and the stopper through-hole 73 are formed to correspond to each other. In the present embodiment, as shown in FIG. 7, the stopper through-hole 73 is formed in a quadrilateral shape, and the projection 31 also has a quadrilateral cross section perpendicular to the protruding direction so that the projection 31 may be inserted into the stopper through-hole 73.

In this case, as shown in FIG. 7, the upper end of the projection 31 may be formed to be inclined so that the stopper 70 may be easily coupled by moving downward from the upper side of the first frame 30. Accordingly, when the stopper protrusion 71 moves along the inclined surface of the projection 31, and the stopper 70 reaches a sufficiently advanced position, the projection 31 is inserted into the stopper through-hole 73 of the stopper protrusion 71.

The number of the projections 31 is formed to correspond to the number of the stopper protrusions 71 of the stopper 70. That is, as shown in FIG. 5, when two pairs of stopper protrusions 71 are disposed at both ends of the stopper 70, two pairs of projections 31 may be formed at positions where the stopper protrusions 71 are fastened.

As shown in FIG. 8, the projection 31 may extend downward toward the first portion 62 of the support member protrusion 61 of the support member 60 while protruding from the side surface of the first frame 30.

Accordingly, the lower end of the projection 31 supports one side of the first portion 62 of the support member protrusion 61. That is, as shown in FIG. 8, even if the first portion 62 is drawn to the outside, the first frame 30 supports both surfaces in the optical axis direction and both surfaces in the first direction of the support member protrusion 61.

This prevents the separation between the support member protrusion 61 and the first frame 30 due to external impact and micro-deformation caused by use as the first portion 62 of the support member protrusion 61 of the support member 60 is exposed to the outside.

As shown in FIGS. 2 and 3, the second frame 40 may be disposed between the first frame 30 and the stopper 70.

In this case, in the present embodiment, the driving unit provides an external force to the second frame 40 so that the second frame 40 may move in the first direction or second direction. However, the present invention is not limited thereto, and an external force may be provided to move the second frame 40 in the optical axis direction as necessary.

As in the present embodiment, when the second frame 40 is moved in the first direction or second direction by the driving unit, the second frame 40 becomes an optical image stabilization (OIS) carrier for camera shake correction. Operations for autofocus will be described later.

The second frame 40 may move in at least one of the first direction and second direction between the first frame 30 and the stopper 70, and the first frame 30 may move in the optical axis direction inside the third frame 50.

In this case, since the second frame 40 is accommodated in the first frame 30, it may be moved together when the first frame 30 is moved.

The lens 10 is mounted on the second frame 40 and accommodated in the third frame 50. Here, the third frame 50 provides a moving space of the lens 10. Accordingly, the lens 10 may be moved together when the second frame 40 and the first frame 30 are moved.

As shown in FIGS. 2 and 3, the second frame 40 is formed to correspond to a space formed between the first frame 30 and the stopper 70. The second frame 40 may be divided into an upper frame and a lower frame.

The second frame 40 has an opening formed at the center thereof to expose the image sensor in the optical axis direction. Accordingly, the image sensor may detect light coming from the lens 10.

When the second frame 40 moves in at least one of the first direction and second direction, the lens 10 is also moved along the second frame 40 to correct the shaking caused by hand tremors in the first direction and second direction, thereby implementing the OIS function.

When the first frame 30 moves forward and backward in the optical axis direction, the lens 10 mounted on the second frame 40 is also moved forward and backward in the optical axis direction to adjust the focal length between the image sensor and the lens 10, thereby implementing the AF function.

Only the case where the lens is driven for the image sensor is described as an example of the present invention, but unlike this, it can be applied as another example of the present invention even when the image sensor is driven for the lens, and can be applied to all forms that combine stoppers and support members, such as the image sensor and the lens dividing their driving roles.

In the above, although the present invention has been described with reference to limited embodiments and drawings, the present invention is not limited thereto and of course can be variously modified and changed by those of ordinary skill in the art within the scope of equivalents of the technical spirit of the present invention and the claims to be described below.

In the above-described description of the present invention, modifiers such as first and second are only instrumental terms used to relatively distinguish components from each other, so they should not be construed as terms used to indicate a specific order, priority, or the like.

The accompanying drawings for the purpose of explaining the present invention and illustrating examples thereof may be shown in a somewhat exaggerated form in order to emphasize or highlight the technical content according to the present invention, but it should be construed as obvious that various types of modified application examples are possible at the level of those skilled in the art in consideration of the above-described contents and the matters shown in the drawings.

1-6. (canceled)

7. A camera module, comprising:
a lens;
a first frame in which the lens is accommodated;
a supporter disposed inside the first frame and configured to have a first portion exposed to the outside of the first frame; and
a stopper coupled to the first frame to form a space for accommodating the lens, wherein the stopper further comprises a second portion directly coupled to the first portion.

8. The camera module of claim 7, wherein the first frame includes a second frame in which the lens is mounted to drive forward and backward along an optical axis direction.

9. The camera module of claim 8, wherein the first frame further includes a third frame disposed between the lens and the second frame or in which the second frame is mounted to drive forward and backward in a direction perpendicular to the optical axis.

10. The camera module of claim 9, wherein the first frame further includes a fourth frame in which the second and third frames are mounted so that they can move forward and backward.

11. The camera module of claim 7, wherein the supporter is integrated with the first frame such that the first portion is exposed to the outside of the first frame.

12. The camera module of claim 7, wherein the stopper and the supporter are made of the same metal material.
